(19) United States
(12) Patent Application Publication
(10) Pub. No.: US 2022/0081790 A1
(43) Pub. Date: Mar. 17, 2022

(54) SOLID OXIDE ELECTROLYSIS CELL (SOEC) AND PREPARATION METHOD THEREOF

(71) Applicant: HUBEI UNIVERSITY, Wuhan (CN)

(72) Inventors: Xunying Wang, Wuhan (CN); Chongqing Liu, Wuhan (CN); Ying Chen, Wuhan (CN); Baoyuan Wang, Wuhan (CN); Wenjing Dong, Wuhan (CN); Chen Xia, Wuhan (CN)

(21) Appl. No.: 17/137,686

(22) Filed: Dec. 30, 2020

(30) Foreign Application Priority Data
Sep. 14, 2020 (CN) 202010959136.0

(51) Int. Cl. C25B 11/091; C25B 11/053

(52) U.S. Cl. CPC C25B 11/091; C25B 11/053

(57) ABSTRACT

The disclosure relates to the technical field of electrolysis cells, and in particular to a solid oxide electrolysis cell (SOEC) and a preparation method thereof. The SOEC provided by the disclosure adopts an n-type TiO₂ layer and a p-type La_{0.6}Sr_{0.4}Co_{0.2}Fe_{0.8}O_{3-δ} layer as an electrolyte layer. Although the n-type TiO₂ and the p-type La_{0.6}Sr_{0.4}Co_{0.2}Fe_{0.8}O_{3-δ} have both ionic and electronic conductivities, the electric field effect of a PN junction between the two layers can effectively cut off the transmission of intermediate layer electrons and enable ions to rapidly pass through. The SOEC can effectively avoid short circuit and exhibit excellent performance. Furthermore, the above structure allows the SOEC to have a stable performance output, and the SOEC can be produced on a large scale due to low material cost.

### CROSS REFERENCE TO RELATED APPLICATION

This application claims priority to Chinese Patent Application No. 202010959136.0, titled “SOLID OXIDE ELECTROLYSIS CELL (SOEC) AND PREPARATION METHOD THEREOF,” filed with the Chinese State Intellectual Property Office on Sep. 14, 2020, the entire disclosure of which is incorporated herein by reference.

### TECHNICAL FIELD

The disclosure relates to the technical field of electrolysis cells, and in particular to a solid oxide electrolysis cell (SOEC) and a preparation method thereof.

### BACKGROUND

The solid oxide electrolysis cell (SOEC) has advantages such as high energy utilization, no precious metal catalyst, and the like. However, traditional high-temperature SOEC needs to work at temperature of about 1,000° C., which results in significant performance degradation (1% to 4%/1,000° C.) and material-cost rise, greatly limiting the commercial development of SOEC. At present, it has become a trend to develop SOEC with a low working temperature (<600° C.). However, the decrease in working temperature will lead to a decrease in the ionic conductivity of electrolyte material, so the traditional electrolyte yttria-stabilized zirconia (YSZ) is not suitable for low-temperature SOEC. The medium-temperature (600° C. to 800° C.) electrolyte material (doped cerium oxide) commonly used at present exhibits a better ionic conductivity than YSZ, but it is still difficult to meet the performance requirements of low-temperature (400° C. to 600° C.) SOEC. In addition, doped cerium oxide is easily reduced under low oxygen partial pressure to show electrical conductivity, which results in a decrease in the energy conversion efficiency of electrolysis cell. Therefore, it is necessary to develop a novel low-temperature electrolyte material to improve the performance of low-temperature SOEC and promote the development thereof.

### SUMMARY

The disclosure is intended to provide an SOEC and a preparation method thereof. The SOEC can effectively avoid the problem of short circuit, has stable performance, and requires low material cost.

To achieve above objective, the disclosure provides the following technical solutions:

The disclosure provides an SOEC, including an anode layer, a cathode layer and an electrolyte layer, where the anode layer includes foamed nickel and a Ni_{0.8}Co_{0.15}Al_{0.05}LiO_{2-y} layer coated on the foamed nickel;

the cathode layer includes foamed nickel and a Ni_{0.8}Co_{0.15}Al_{0.05}LiO_{2-y} layer coated on the foamed nickel;

the electrolyte layer includes an n-type TiO₂ layer and a p-type La_{0.6}Sr_{0.4}Co_{0.2}Fe_{0.8}O_{3-δ} layer that are stacked;

the Ni_{0.8}Co_{0.15}Al_{0.05}LiO_{2-y} layer in the anode layer is in contact with the n-type TiO₂ layer; and

the Ni_{0.8}Co_{0.15}Al_{0.05}LiO_{2-y} layer in the cathode layer is in contact with the p-type La_{0.6}Sr_{0.4}Co_{0.2}Fe_{0.8}O_{3-δ} layer;

where, y has a value range of 0<y<2, and δ has a value range of 0<δ<3.

Preferably, the n-type TiO₂ layer and the SOEC have a thickness ratio of 1:(5-15).

Preferably, the p-type La_{0.6}Sr_{0.4}Co_{0.2}Fe_{0.8}O_{3-δ} layer and the SOEC have a thickness ratio of 1:(2-10).

Preferably, the Ni_{0.8}Co_{0.15}Al_{0.05}LiO_{2-y} layer in the anode layer and the SOEC have a thickness ratio of 1:(2-5); and

the Ni_{0.8}Co_{0.15}Al_{0.05}LiO_{2-y} layer in the cathode layer and the SOEC have a thickness ratio of 1:(2-10).

The disclosure further provides a method for preparing the SOEC according to the above technical solution, including the following steps:

mixing Ni_{0.8}Co_{0.15}Al_{0.05}LiO_{2-y} with terpineol to give an electrode slurry;

coating the electrode slurry on the upper surface of foamed nickel, and then curing to give an anode layer and a cathode layer, separately; and

spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC; where

y has a value range of 0<y<2, and δ has a value range of 0<δ<3.

Preferably, the Ni_{0.8}Co_{0.15}Al_{0.05}LiO_{2-y} and the terpineol are mixed at a mass ratio of 1:(2-4).

Preferably, the curing is conducted at 60° C. to 150° C. for 5 min to 20 min.

Preferably, the TiO₂ powder and the La_{0.6}Sr_{0.4}Co_{0.2}Fe_{0.8}O_{3-δ} powder have a mass ratio of (0.05-0.2):(0.2-0.4);

the Ni_{0.8}Co_{0.15}Al_{0.05}LiO_{2-y} in the anode layer and the TiO₂ powder have a mass ratio of 1:(0.1-0.4); and

the Ni_{0.8}Co_{0.15}Al_{0.05}LiO_{2-y} in the cathode layer and the La_{0.6}Sr_{0.4}Co_{0.2}Fe_{0.8}O_{3-δ} powder have a mass ratio of 1:(0.5-2).

Preferably, the pressing is conducted under a pressure of 150 MPa to 250 MPa, and the pressure is held for 1 min to 5 min.

The disclosure provides an SOEC, including an anode layer, a cathode layer and an electrolyte layer. The anode layer includes foamed nickel and a Ni_{0.8}Co_{0.15}Al_{0.05}LiO_{2-y} layer coated on the foamed nickel; the cathode layer includes foamed nickel and a Ni_{0.8}Co_{0.15}Al_{0.05}LiO_{2-y} layer coated on the foamed nickel; the electrolyte layer includes an n-type TiO₂ layer and a p-type La_{0.6}Sr_{0.4}Co_{0.2}Fe_{0.8}O_{3-δ} layer that are stacked; the Ni_{0.8}Co_{0.15}Al_{0.05}LiO_{2-y} layer in the anode layer is in contact with the n-type TiO₂ layer; and the Ni_{0.8}Co_{0.15}Al_{0.05}LiO_{2-y} layer in the cathode layer is in contact with the p-type La_{0.6}Sr_{0.4}Co_{0.2}Fe_{0.8}O_{3-δ} layer; where y has a value range of 0<y<2, and δ has a value range of 0<δ<3. The disclosure adopts the n-type TiO₂ layer and the p-type La_{0.6}Sr_{0.4}Co_{0.2}Fe_{0.8}O_{3-δ} layer as an electrolyte layer. Although the n-type TiO₂ and the p-type La_{0.6}Sr_{0.4}Co_{0.2}Fe_{0.8}O_{3-δ} have both ionic and electronic conductivities, the electric field effect of a PN junction between the two layers can effectively cut off the transmission of intermediate layer electrons and enable ions to rapidly pass through. Thus, the SOEC can effectively avoid the problem of short circuit and has the possibility of exhibiting excellent performance. Furthermore, the above structure allows the SOEC to have a stable performance output, and the SOEC can be produced on a large scale due to low material cost.

### BRIEF DESCRIPTION OF DRAWINGS

FIG. 1 is a structure diagram of the SOEC according to the disclosure;

FIG. 2 shows i-V curves of the SOEC prepared in Example 2 at different temperatures; and

FIG. 3 shows an i-t curve of the SOEC prepared in Example 2 at 550° C.

### DETAILED DESCRIPTION

The disclosure provides an SOEC, including an anode layer, a cathode layer and an electrolyte layer. The anode layer includes foamed nickel and a Ni_{0.8}Co_{0.15}Al_{0.05}LiO_{2-y} layer coated on the foamed nickel;

the cathode layer includes foamed nickel and a Ni_{0.8}Co_{0.15}Al_{0.05}LiO_{2-y} layer coated on the foamed nickel;

the electrolyte layer includes an n-type TiO₂ layer and a p-type La_{0.6}Sr_{0.4}Co_{0.2}Fe_{0.8}O_{3-δ} layer that are stacked;

the Ni_{0.8}Co_{0.15}Al_{0.05}LiO_{2-y} layer in the anode layer is in contact with the n-type TiO₂ layer; and

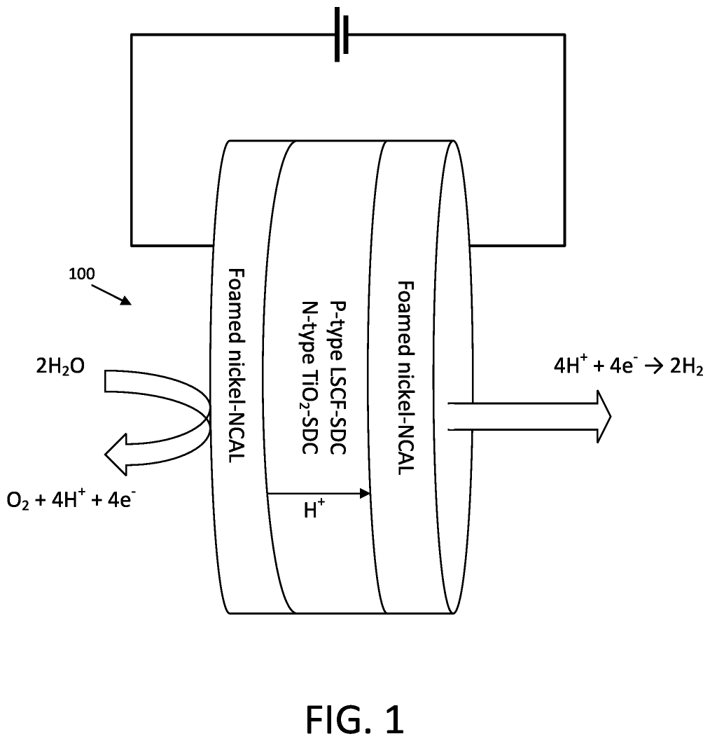

the Ni_{0.8}Co_{0.15}Al_{0.05}LiO_{2-y} layer in the cathode layer is in contact with the p-type La_{0.6}Sr_{0.4}Co_{0.2}Fe_{0.8}O_{3-δ} layer;

where, y has a value range of 0<y<2, and δ has a value range of 0<δ<3 (the structure diagram of the SOEC 100 is shown in FIG. 1).

In the disclosure, a PN junction is formed at the interface between the n-type TiO₂ layer and the p-type La_{0.6}Sr_{0.4}Co_{0.2}Fe_{0.8}O_{3-δ} layer.

In the disclosure, the n-type TiO₂ layer and the SOEC have a thickness ratio preferably of 1:(5-15), and more preferably of 1:(8-12).

In the disclosure, the p-type La_{0.6}Sr_{0.4}Co_{0.2}Fe_{0.8}O_{3-δ} layer and the SOEC have a thickness ratio preferably of 1:(2-10), and more preferably of 1:(4-7).

In the disclosure, the Ni_{0.8}Co_{0.15}Al_{0.05}LiO_{2-y} layer in the anode layer and the SOEC have a thickness ratio preferably of 1:(2-5), and more preferably of 1:(3-4); and the Ni_{0.8}Co_{0.15}Al_{0.05}LiO_{2-y} layer in the cathode layer and the SOEC have a thickness ratio preferably of 1:(2-10), and more preferably of 1:(4-8).

The disclosure further provides a method for preparing the SOEC according to the above technical solution, including the following steps:

mixing Ni_{0.8}Co_{0.15}Al_{0.05}LiO_{2-y} with terpineol to give an electrode slurry;

coating the electrode slurry on the upper surface of foamed nickel, and then curing to give an anode or cathode layer; and

spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC;

y has a value range of 0<y<2, and δ has a value range of 0<δ<3.

In the disclosure, unless otherwise specified, all raw materials are commercially-available products well known to those skilled in the art.

In the disclosure, Ni_{0.8}Co_{0.15}Al_{0.05}LiO_{2-y} (NCAL) is mixed with terpineol to give an electrode slurry. In the disclosure, the NCAL and terpineol are mixed at a mass ratio preferably of 1:(2-4), more preferably of 1:(2.5-3.5), and most preferably of 1:3. In the disclosure, the mixing is preferably conducted under stirring. The disclosure has no special limitation on the stirring, and a process well known to those skilled in the art may be adopted.

In the disclosure, after the electrode slurry is obtained, the electrode slurry is coated on the upper surface of foamed nickel and then cured to give an anode or cathode layer. The disclosure has no special limitation on the coating, and a process well known to those skilled in the art may be adopted. In the disclosure, the curing is conducted preferably at 60° C. to 150° C., more preferably at 80° C. to 120° C., and most preferably at 90° C. to 110° C.; and the curing is conducted preferably for 5 min to 20 min, more preferably for 8 min to 16 min, and most preferably for 10 min to 15 min. The disclosure has no special limitation on an amount at which the electrode slurry is coated, provided that “the Ni_{0.8}Co_{0.15}Al_{0.05}LiO_{2-y} layer in the anode layer and the SOEC have a thickness ratio of 1:(2-5); and the p-type La_{0.6}Sr_{0.4}Co_{0.2}Fe_{0.8}O_{3-δ} layer in the cathode layer and the SOEC have a thickness ratio of 1:(2-10)”.

After the curing is completed, the disclosure preferably also includes cooling. The disclosure has no special limitation on the cooling, and a process well known to those skilled in the art may be adopted for cooling to room temperature.

In the disclosure, after the anode and cathode layers are obtained, a TiO₂ powder and a La_{0.6}Sr_{0.4}Co_{0.2}Fe_{0.8}O_{3-δ} powder are spread in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then the Ni_{0.8}Co_{0.15}Al_{0.05}LiO_{2-y} layer of the cathode layer is arranged to be in contact with the p-type La_{0.6}Sr_{0.4}Co_{0.2}Fe_{0.8}O_{3-δ} layer; and pressing is conducted to give the SOEC; y has a value range of 0<y<2, and δ has a value range of 0<δ<3. The disclosure has no special limitation on the spreading, and a process well known to those skilled in the art may be adopted. In the disclosure, the TiO₂ powder has a particle size preferably of 20 nm to 500 nm, and more preferably of 100 nm to 300 nm; and the LSCF powder has a particle size preferably of 100 nm to 1,000 nm, and more preferably of 200 nm to 700 nm. In the disclosure, the TiO₂ powder and the La_{0.6}Sr_{0.4}Co_{0.2}Fe_{0.8}O_{3-δ} powder have a mass ratio preferably of (0.05-0.2):(0.2-0.4), and more preferably of (0.08-0.18):(0.22-0.32); the Ni_{0.8}Co_{0.15}Al_{0.05}LiO_{2-y} in the anode layer and the TiO₂ powder have a mass ratio preferably of 1:(0.1-0.4), and more preferably of 1:(0.15-0.3); and the Ni_{0.8}Co_{0.15}Al_{0.05}LiO_{2-y} in the cathode layer and the La_{0.6}Sr_{0.4}Co_{0.2}Fe_{0.8}O_{3-δ} powder have a mass ratio preferably of 1:(0.5-2), and more preferably of 1:(0.8-1.5).

In the disclosure, the pressing is conducted under a pressure preferably of 150 MPa to 250 MPa, and more preferably of 180 MPa to 220 MPa; and the pressure is held preferably for 1 min to 5 min, and more preferably for 2 min to 3 min.

The technical solutions in the disclosure will be clearly and completely described below in conjunction with the examples of the disclosure. Apparently, the described examples are merely some rather than all of the examples of the disclosure. All other examples obtained by a person of ordinary skill in the art based on the examples of the disclosure without creative efforts shall fall within the protection scope of the disclosure.

### EXAMPLE 1

1 g of NCAL and 3 g of terpineol were mixed under stirring to give an electrode slurry.

0.4 g of the electrode slurry was coated on the upper surface of foamed nickel and then cured at 120° C. for 10 min, and a resulting product was cooled to room temperature to give an anode layer.

0.3 g of the electrode slurry was coated on the upper surface of foamed nickel and then cured at 120° C. for 10 min, and a resulting product was cooled to room temperature to give a cathode layer.

0.1 g of a TiO₂ powder was evenly spread on the surface of the Ni_{0.8}Co_{0.15}Al_{0.05}LiO_{2-y} layer of the anode layer, and a resulting product was gently flattened manually; 0.3 g of a La_{0.6}Sr_{0.4}Co_{0.2}Fe_{0.8}O_{3-δ} powder was evenly spread on the surface of the TiO₂ layer, and a resulting product was gently flattened manually; and then the Ni_{0.8}Co_{0.15}Al_{0.05}LiO_{2-y} layer of the cathode layer was arranged to be in contact with the p-type La_{0.6}Sr_{0.4}Co_{0.2}Fe_{0.8}O_{3-δ} layer, and pressing was conducted under a pressure of 200 MPa to give the SOEC (the n-type TiO₂ layer had a thickness of 0.2 mm; and the p-type La_{0.6}Sr_{0.4}Co_{0.2}Fe_{0.8}O_{3-δ} layer had a thickness of 0.4 mm).

### EXAMPLE 2

1 g of NCAL and 3 g of terpineol were mixed under stirring to give an electrode slurry.

0.5 g of the electrode slurry was coated on the upper surface of foamed nickel and then cured at 80° C. for 15 min, and a resulting product was cooled to room temperature to give an anode layer.

0.5 g of the electrode slurry was coated on the upper surface of foamed nickel and then cured at 80° C. for 15 min, and a resulting product was cooled to room temperature to give a cathode layer.

0.08 g of a TiO₂ powder was evenly spread on the surface of the Ni_{0.8}Co_{0.15}Al_{0.05}LiO_{2-y} layer of the anode layer, and a resulting product was gently flattened manually; 0.32 g of a La_{0.6}Sr_{0.4}Co_{0.2}Fe_{0.8}O_{3-δ} powder was evenly spread on the surface of the TiO₂ layer, and a resulting product was gently flattened manually; and then the Ni_{0.8}Co_{0.15}Al_{0.05}LiO_{2-y} layer of the cathode layer was arranged to be in contact with the p-type La_{0.6}Sr_{0.4}Co_{0.2}Fe_{0.8}O_{3-δ} layer, and pressing was conducted under a pressure of 170 MPa to give the SOEC (the n-type TiO₂ layer had a thickness of 0.15 mm; and the p-type La_{0.6}Sr_{0.4}Co_{0.2}Fe_{0.8}O_{3-δ} layer had a thickness of 0.45 mm).

### EXAMPLE 3

1 g of NCAL and 3 g of terpineol were mixed under stirring to give an electrode slurry.

0.6 g of the electrode slurry was coated on the upper surface of foamed nickel and then cured at 100° C. for 10 min, and a resulting product was cooled to room temperature to give an anode layer.

0.3 g of the electrode slurry was coated on the upper surface of foamed nickel and then cured at 100° C. for 10 min, and a resulting product was cooled to room temperature to give a cathode layer.

0.15 g of a TiO₂ powder was evenly spread on the surface of the Ni_{0.8}Co_{0.15}Al_{0.05}LiO_{2-y} layer of the anode layer, and a resulting product was gently flattened manually; 0.4 g of a La_{0.6}Sr_{0.4}Co_{0.2}Fe_{0.8}O_{3-δ} powder was evenly spread on the surface of the TiO₂ layer, and a resulting product was gently flattened manually; and then the Ni_{0.8}Co_{0.15}Al_{0.05}LiO_{2-y} layer of the cathode layer was arranged to be in contact with the p-type La_{0.6}Sr_{0.4}Co_{0.2}Fe_{0.8}O_{3-δ} layer, and pressing was conducted under a pressure of 220 MPa to give the SOEC (the n-type TiO₂ layer had a thickness of 0.4 mm; and the p-type La_{0.6}Sr_{0.4}Co_{0.2}Fe_{0.8}O_{3-δ} layer had a thickness of 0.6 mm).

### EXAMPLE 4

1 g of NCAL and 2 g of terpineol were mixed under stirring to give an electrode slurry.

0.7 g of the electrode slurry was coated on the upper surface of foamed nickel and then cured at 100° C. for 15 min, and a resulting product was cooled to room temperature to give an anode layer.

0.3 g of the electrode slurry was coated on the upper surface of foamed nickel and then cured at 100° C. for 15 min, and a resulting product was cooled to room temperature to give a cathode layer.

0.12 g of a TiO₂ powder was evenly spread on the surface of the Ni_{0.8}Co_{0.15}Al_{0.05}LiO_{2-y} layer of the anode layer, and a resulting product was gently flattened manually; 0.38 g of a La_{0.6}Sr_{0.4}Co_{0.2}Fe_{0.8}O_{3-δ} powder was evenly spread on the surface of the TiO₂ layer, and a resulting product was gently flattened manually; and then the Ni_{0.8}Co_{0.15}Al_{0.05}LiO_{2-y} layer of the cathode layer was arranged to be in contact with the p-type La_{0.6}Sr_{0.4}Co_{0.2}Fe_{0.8}O_{3-δ} layer, and pressing was conducted under a pressure of 220 MPa to give the SOEC (the n-type TiO₂ layer had a thickness of 0.3 mm; and the p-type La_{0.6}Sr_{0.4}Co_{0.2}Fe_{0.8}O_{3-δ} layer had a thickness of 0.6 mm).

### TEST EXAMPLE

The SOEC prepared in Example 2 was tested according to the following steps:

1. The SOEC was fixed on a test fixture and then placed in a tube furnace, and the test temperature was set to 450° C.

2. A water delivery device was used to deliver water via a pipe of the fixture at a rate of 30 s/drop, and the water was delivered at the TiO₂ side.

3. An applied voltage of a voltage device was adjusted to 0 V, 0.1 V, 0.2 V, 0.3 V, 0.4 V, 0.5 V, 0.6 V, 0.7 V, 0.8 V, 0.9 V, 1.0 V, 1.2 V, 1.3 V, 1.4 V, 1.45 V, 1.5 V, 1.55 V, 1.6 V, 1.7 V, 1.8 V, 1.85 V, 1.9 V, and 2.0 V, separately; and then the corresponding current and voltage data were recorded.

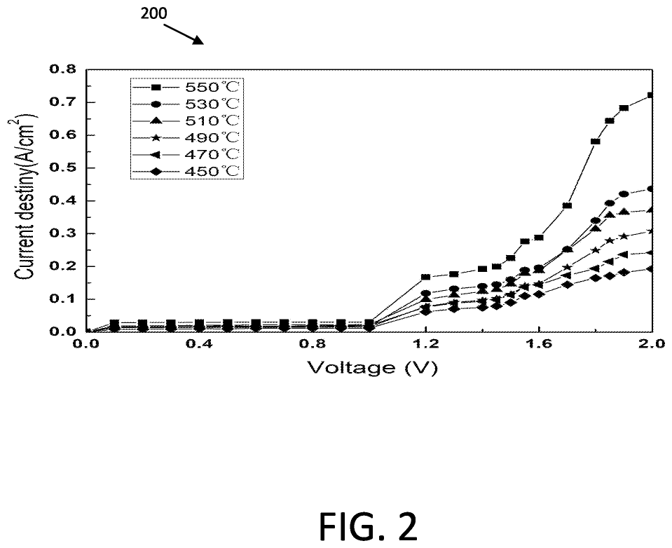

4. The test temperature was set to 450° C., 470° C., 490° C., 510° C., 530° C. and 550° C., separately, and steps 2 and 3 were repeated to test the performance of the SOEC at different temperatures. Test results 200 are shown in FIG. 2. It can be seen from FIG. 2 that, when a forward voltage of 1.8 V is applied to the anode and water is supplied at the anode, the current density of the SOEC is 0.16479 A/cm² and 0.58063 A/cm² at 550° C. and 450° C., respectively.

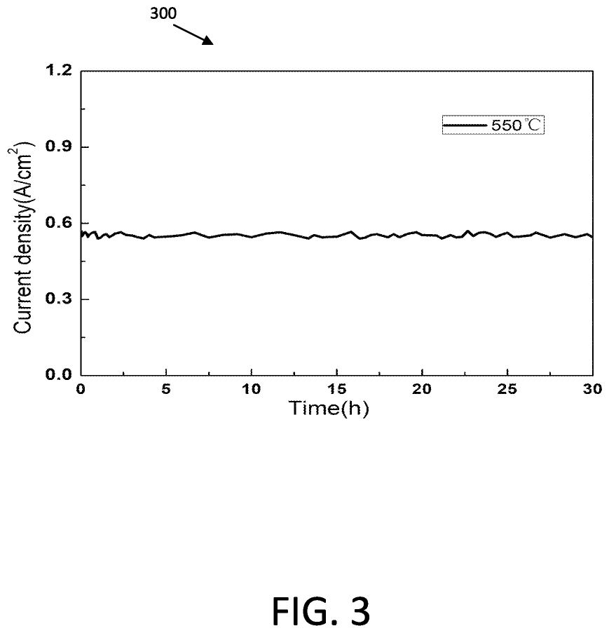

5. The test temperature was set to 550° C., and a stability test was conducted. Test results 300 are shown in FIG. 3.

It can be seen from FIG. 3 that the SOEC exhibits no performance degradation within the 30 h when the SOEC operates at 2 V and 550° C.

The above descriptions are merely preferred implementations of the disclosure. It should be noted that a person of ordinary skill in the art may further make several improvements and modifications without departing from the principle of the disclosure, but such improvements and modifications should be deemed as falling within the protection scope of the disclosure.

What is claimed is:

1. A solid oxide electrolysis cell (SOEC), comprising an anode layer, a cathode layer and an electrolyte layer, wherein the anode layer comprises foamed nickel and a Ni_{0.8}Co_{0.15}Al_{0.05}LiO_{2-y} layer coated on the foamed nickel;
the cathode layer comprises foamed nickel and a Ni_{0.8}Co_{0.15}Al_{0.05}LiO_{2-y} layer coated on the foamed nickel;
the electrolyte layer comprises an n-type TiO₂ layer and a p-type La_{0.6}Sr_{0.4}Co_{0.2}Fe_{0.8}O_{3-δ} layer that are stacked;
the Ni_{0.8}Co_{0.15}Al_{0.05}LiO_{2-y} layer in the anode layer is in contact with the n-type TiO₂ layer; and
the Ni_{0.8}Co_{0.15}Al_{0.05}LiO_{2-y} layer in the cathode layer is in contact with the p-type La_{0.6}Sr_{0.4}Co_{0.2}Fe_{0.8}O_{3-δ} layer;
wherein, y has a value range of 0<y<2, and δ has a value range of 0<δ<3.

2. The SOEC according to claim 1, wherein the n-type TiO₂ layer and the SOEC have a thickness ratio of 1:(5-15).

3. The SOEC according to claim 1, wherein the p-type La_{0.6}Sr_{0.4}Co_{0.2}Fe_{0.8}O_{3-δ} layer and the SOEC have a thickness ratio of 1:(2-10).

4. The SOEC according to claim 1, wherein the Ni_{0.8}Co_{0.15}Al_{0.05}LiO_{2-y} layer in the anode layer and the SOEC have a thickness ratio of 1:(2-5); and
the Ni_{0.8}Co_{0.15}Al_{0.05}LiO_{2-y} layer in the cathode layer and the SOEC have a thickness ratio of 1:(2-10).

5. A method for preparing the SOEC according to claim 1, comprising the following steps:
mixing Ni_{0.8}Co_{0.15}Al_{0.05}LiO_{2-y} with terpineol to give an electrode slurry;
coating the electrode slurry on the upper surface of foamed nickel, and then curing to give an anode layer and a cathode layer, separately; and
spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC; wherein
y has a value range of 0<y<2, and δ has a value range of 0<δ<3.

6. A method for preparing the SOEC according to claim 2, comprising the following steps:
mixing Ni_{0.8}Co_{0.15}Al_{0.05}LiO_{2-y} with terpineol to give an electrode slurry;
coating the electrode slurry on the upper surface of foamed nickel, and then curing to give an anode layer and a cathode layer, separately; and
spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC; wherein
y has a value range of 0<y<2, and δ has a value range of 0<δ<3.

7. A method for preparing the SOEC according to claim 3, comprising the following steps:
mixing Ni_{0.8}Co_{0.15}Al_{0.05}LiO_{2-y} with terpineol to give an electrode slurry;
coating the electrode slurry on the upper surface of foamed nickel, and then curing to give an anode layer and a cathode layer, separately; and
spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC; wherein
y has a value range of 0<y<2, and δ has a value range of 0<δ<3.

8. A method for preparing the SOEC according to claim 4, comprising the following steps:
mixing Ni_{0.8}Co_{0.15}Al_{0.05}LiO_{2-y} with terpineol to give an electrode slurry;
coating the electrode slurry on the upper surface of foamed nickel, and then curing to give an anode layer and a cathode layer, separately; and
spreading a TiO₂ powder and a La_{0.6}Sr_{0.4}Co_{0.2}Fe_{0.8}O_{3-δ} powder in sequence on the surface of the Ni_{0.8}Co_{0.15}Al_{0.05}LiO_{2-y} layer of the anode layer to give a TiO₂ layer and a p-type La_{0.6}Sr_{0.4}Co_{0.2}Fe_{0.8}O_{3-δ} layer; then arranging the Ni_{0.8}Co_{0.15}Al_{0.05}LiO_{2-y} layer of the cathode layer to be in contact with the p-type La_{0.6}Sr_{0.4}Co_{0.2}Fe_{0.8}O_{3-δ} layer; and pressing to give the SOEC; wherein
y has a value range of 0<y<2, and δ has a value range of 0<δ<3.

9. The preparation method according to claim 5, wherein the Ni_{0.8}Co_{0.15}Al_{0.05}LiO_{2-y} and the terpineol are mixed at a mass ratio of 1:(2-4).

10. The preparation method according to claim 6, wherein the Ni_{0.8}Co_{0.15}Al_{0.05}LiO_{2-y} and the terpineol are mixed at a mass ratio of 1:(2-4).

11. The preparation method according to claim 7, wherein the Ni_{0.8}Co_{0.15}Al_{0.05}LiO_{2-y} and the terpineol are mixed at a mass ratio of 1:(2-4).

12. The preparation method according to claim 8, wherein the Ni_{0.8}Co_{0.15}Al_{0.05}LiO_{2-y} and the terpineol are mixed at a mass ratio of 1:(2-4).

13. The preparation method according to claim 5, wherein the curing is conducted at 60° C. to 150° C. for 5 min to 20 min.

14. The method according to claim 6, wherein the curing is conducted at 60° C. to 150° C. for 5 min to 20 min.

15. The preparation method according to claim 7, wherein the curing is conducted at 60° C. to 150° C. for 5 min to 20 min.

16. The preparation method according to claim 8, wherein the curing is conducted at 60° C. to 150° C. for 5 min to 20 min.

17. The preparation method according to claim 9, wherein the curing is conducted at 60° C. to 150° C. for 5 min to 20 min.

18. The preparation method according to claim 10, wherein the curing is conducted at 60° C. to 150° C. for 5 min to 20 min.

19. The preparation method according to claim 5, wherein the TiO₂ powder and the La_{0.6}Sr_{0.4}Co_{0.2}Fe_{0.8}O_{3-δ} powder have a mass ratio of (0.05-0.2):(0.2-0.4);
the Ni_{0.8}Co_{0.15}Al_{0.05}LiO_{2-y} in the anode layer and the TiO₂ powder have a mass ratio of 1:(0.1-0.4); and
the Ni_{0.8}Co_{0.15}Al_{0.05}LiO_{2-y} in the cathode layer and the La_{0.6}Sr_{0.4}Co_{0.2}Fe_{0.8}O_{3-δ} powder have a mass ratio of 1:(0.5-2).

20. The preparation method according to claim 5, wherein the pressing is conducted under a pressure of 150 MPa to 250 MPa, and the pressure is held for 1 min to 5 min.
